(19) United States
(12) Patent Application Publication
(10) Pub. No.: US 2009/0000897 A1
(43) Pub. Date: Jan. 1, 2009

(54) Hydraulic control for a dual clutch transmission

(75) Inventors: Martin Staudinger, Ettlingen (DE); Eric Mueller, Kaiserslautern (DE); Felix Dreher, Buehl (DE)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/231,434

(22) Filed: Sep. 3, 2008

Related U.S. Application Data
(63) Continuation of application No. PCT/DE2007/000253, filed on Feb. 12, 2007.

(30) Foreign Application Priority Data
Mar. 8, 2006 (DE) 10 2006 010 631.8

(51) Int. Cl. F16D 21/00; F16D 31/00

(52) U.S. Cl. 192/48.1; 192/58.2

(57) ABSTRACT

A dual clutch transmission comprising a first clutch (16), which is hydraulically actuated by a first hydraulic cylinder (19), and a second clutch (18), which is hydraulically actuated by a second hydraulic cylinder (20), in addition to a plurality of hydraulically actuated shift cylinders (11, 12, 13, 14) for shifting gears, which can be subjected to pressure (p1, p2) by means of a selector valve arrangement (51), wherein the first hydraulic cylinder (19) and the second hydraulic cylinder (20) and the selector valve arrangement (51) are connected to a pressure side of a pressure device (24, 25, 26, 27, 28) by means of safety valves (52, 53, 54), which are actuated in unison.

### CROSS-REFERENCE TO RELATED APPLICATIONS

This application is filed under 35 U.S.C. §120 and §365(c) as a continuation of International Patent Application PCT/DE2007/000253, filed Feb. 12, 2007, which application is incorporated herein by reference. This application also claims priority from German Patent Application No. 10 2006 010 631.8, filed Mar. 8, 2006, which application is incorporated herein by reference.

### FIELD OF THE INVENTION

The present invention relates to a dual clutch transmission as well as a hydraulic system for actuating a dual clutch transmission.

### BACKGROUND

It is known to shift gear-changing transmissions, in particular dual clutch transmissions, hydraulically, as well as to actuate the two clutches hydraulically.

Dual clutch transmissions of this sort are not inherently “fail-safe.” For example, if both gear train clutches are engaged simultaneously with a gear selected, the transmission jams. In the event of an error, it is therefore necessary to convert the transmission to a safe state reliably and quickly. The object of the present invention is therefore to specify a hydraulic control for a dual clutch transmission that can shift and clutch by the simplest means possible, and that can be converted to a safe state with only one action, if possible.

### SUMMARY OF THE INVENTION

This problem is solved by a dual clutch transmission comprising a first clutch, which is hydraulically actuated by a first hydraulic cylinder, and a second clutch, which is hydraulically actuated by a second hydraulic cylinder, in addition to several hydraulically actuated shift cylinders for shifting gears, which can be pressurized by means of a selector valve arrangement, wherein the first hydraulic cylinder and the second hydraulic cylinder and the selector valve arrangement are connected to the pressure side of a pressure device by means of safety valves, which are actuated in unison. Preferably provision is made for the safety valves to connect the first hydraulic cylinder and the second hydraulic cylinder and the selector valve arrangement to the pressure device in an operating position, and to separate the first hydraulic cylinder and the second hydraulic cylinder and the selector valve arrangement from the pressure device in an emergency position. Preferably provision is made for the first hydraulic cylinder and the second hydraulic cylinder to be depressurized in the emergency position. Furthermore, by preference provision is made for the shift cylinders to be depressurized in the emergency position. With such a valve system, it is possible by actuating a single valve, namely the safety valve, to convert the entire transmission including the dual clutch to a safe state, in which both clutches are disengaged and the shift state of the transmission is frozen. The safety valves are preferably combined in a safety valve block.

Preferably provision is made for each shift cylinder of a double piston to be connected to an output of a reversing valve, where the reversing valve includes a plurality of outputs and one output is connected to a first input of the reversing valve and the rest of the outputs are connected to a second input of the reversing valve in a hydraulically conductive connection, and where the shift cylinders of the double pistons that are not connected to an output of the reversing valve are connected to the second input of the reversing valve and the first and second inputs of the reversing valve can be pressurized alternately with the high or low pressure. The pistons of two shift cylinders at a time are preferably coupled together into a double piston, where one shift cylinder in each instance can be pressured with a high pressure and the other shift cylinders can be pressurized with a low pressure. The reversing valve is preferably a rotary valve. Preferably provision is made for the first input of the reversing valve to be connected to a first output of a shifting pressure regulating valve and for the second input of the reversing valve to be connected to a second output of the shifting pressure regulating valve, where the first and second outputs of the shifting pressure regulating valve can be connected alternately to an input of the shifting pressure regulating valve at which the high pressure is present and an input at which the low pressure is present. The pressure device is preferably a pressure accumulator, which is charged with a hydraulic fluid by a hydraulic pump. The high pressure is preferably approximately the pressure on the pressure side of the hydraulic pump and the low pressure approximately the pressure on the suction side of the hydraulic pump. This approximately means that these pressure values may be somewhat lower due to interposed elements which have for example a throttling effect. The pressure on the suction side of the pump here is preferably approximately the pressure in a tank for a hydraulic fluid, and thus approximately the ambient pressure.

This problem named at the beginning is also solved by a hydraulic system, in particular for actuating a dual clutch transmission comprising a first clutch, which is hydraulically actuated by a first hydraulic cylinder, and a second clutch, which is hydraulically actuated by a second hydraulic cylinder, in addition to several hydraulically actuated shift cylinders for shifting gears, which can be pressurized by means of a selector valve arrangement, wherein the first hydraulic cylinder and the second hydraulic cylinder and the selector valve arrangement are connected to the pressure side of a pressure device by means of safety valves, which are actuated in unison. Refinements of the hydraulic system have the features or combinations of features named in the subordinate claims for the dual clutch transmission according to the invention.

### BRIEF DESCRIPTION OF THE DRAWINGS

Exemplary embodiments of the invention will now be explained on the basis of the accompanying drawing. The figures show the following:

FIG. 1 is schematic depiction of a dual clutch transmission according to the current invention.

### DETAILED DESCRIPTION OF THE INVENTION

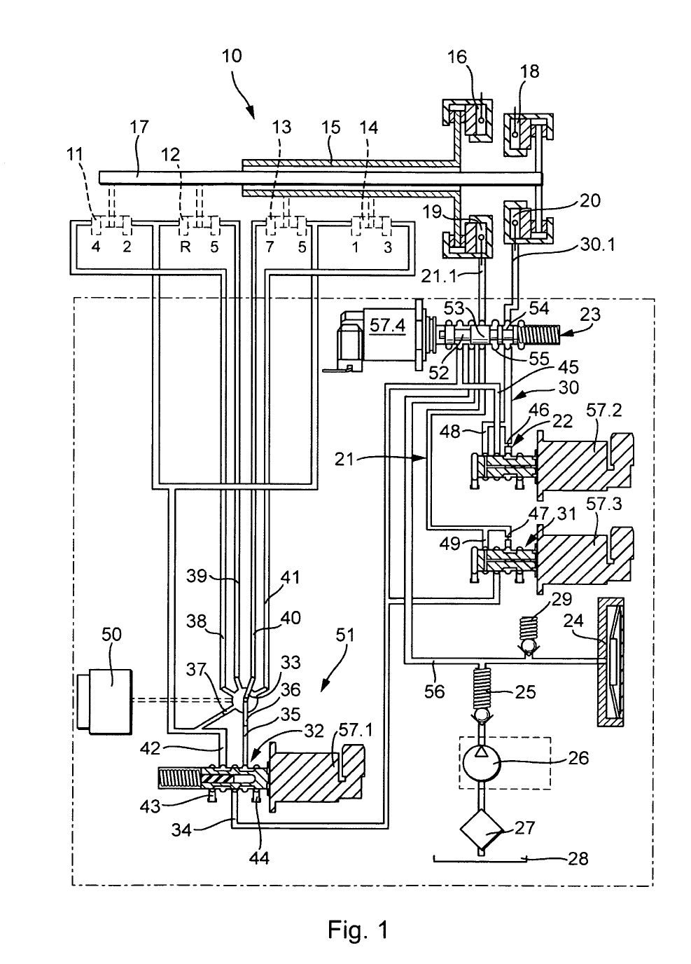

FIG. 1 shows an exemplary embodiment of dual clutch transmission 10 according to the invention, which is depicted only schematically here. In the present exemplary embodiment an 8-gear transmission is assumed, comprising seven forward gears and one reverse gear. The individual gears are shifted by shift cylinders 11, 12, 13 and 14. In the exemplary embodiment, shift cylinder 11 shifts gears two and four, shift cylinder 12 shifts the reverse gear and gear six, shift cylinder 13 gears five and seven and shift cylinder 14 gears one and three. The shift cylinders are hydraulically actuated and have two end positions, each of which corresponds to one of the two gears, as well as a middle position in which neither of the two gears is selected. FIG. 1 indicates schematically that gears one, three, five and seven, i.e., all of the odd numbered gears, interact with first transmission input shaft 15, which may be engaged with or disengaged from the crankshaft of a combustion engine (not shown) by means of first hydraulically actuated clutch 16 (hydraulic clutch). Correspondingly, gears two, four, six and the reverse gear interact with second transmission input shaft 17, which can be engaged with or disengaged from the crankshaft of the combustion engine (not shown) by means of second hydraulically actuated clutch 18. Clutches 16 and 18 are depicted only schematically here; these are hydraulically actuated wet clutches, or alternatively hydraulically actuated dry clutches. Furthermore, first clutch 16 is actuated by first hydraulic cylinder 19 and second clutch 18 is actuated by second hydraulic cylinder 20. First hydraulic cylinder 19 is connected to volume flow regulating valve 22 through hydraulic line 21. Volume flow regulating valve 22 is connected to pressure accumulator 24 through safety valve block 23, which comprises a plurality of valves explained below, and pressure accumulator line 56. Pressure accumulator 24 is connected to tank 28 through check valve 25, pump 26 and oil filter 27. Pump 26 transports hydraulic oil from tank 28 into pressure accumulator 24 through oil filter 27. Also situated in the vicinity of pressure accumulator 24 is pressure relief valve 29, which limits the maximum pressure in pressure accumulator 24 and the subsequent components. Pressure accumulator 24, check valve 25, pump 26, oil filter 27, tank 28 and pressure relief valve 29 are parts of a pressure device.

Second hydraulic cylinder 20 is connected to second volume flow regulating valve 31 through hydraulic line 30. Volume flow regulating valve 31 separates hydraulic line 21 into line segment 21.1 that is connected to hydraulic cylinder 19 and line segment 21.2 that is connected to volume flow regulating valve 31. Correspondingly, volume flow regulating valve 22 separates hydraulic line 30 into line segment 30.1 that is connected to hydraulic cylinder 20 and line segment 30.2 that is connected to volume flow regulating valve 22.

Shifting pressure regulating valve 32 has input 34. Output 35 of shifting pressure regulating valve 32 is connected to rotary valve 33 as a reversing valve. Rotary valve 33 has input 36, which can be connected hydraulically to outputs 38, 39, 40 and 41. In addition to first input 36, rotary valve 33 has second input 37, with all outputs 38, 39, 40 or 41 that are not connected to input 36 being connected to second input 37. Thus there is always exactly one output 38 or 39 or 40 or 41 connected to input 36; all other outputs are connected to second input 37. Rotary valve 33 is actuated by electric stepper motor 50. Rotary valve 33 and shifting pressure regulating valve 32 are referred to together as selector valve arrangement 51.

In the depiction in FIG. 1, output 38 is connected to shift cylinder 11 on the side that serves to shift the second gear. Output 39 is connected to shift cylinder 12 on the side that serves to shift the reverse gear. Output 40 is connected to shift cylinder 13 on the side that serves to shift the fifth gear, and output 41 is connected to shift cylinder 14 on the side that serves to shift the first gear. The other sides of the respective shift cylinders 11, 12, 13 and 14 are connected in common to output 42 of shifting pressure regulating valve 32. Shifting pressure regulating valve 32 has three selector positions whereby in first selector position input 34 is connected to output 35, while at the same time output 42 is connected via first return line 43 to tank 28. Second valve position input 34 is connected to output 42, while at the same time output 35 is connected via return line 44 to tank 28. Thus outputs 35 and 42 are alternately pressurized, while the other output in each case is depressurized. The third selector position is located precisely between the first and the second. Here both output 35 and output 42 are connected via ducts 43 and 44 to the tank, thus guaranteeing that no pressure gets into the shift cylinders. First pressure p1 and second pressure p2 here designate the (high) pressure in the case of a connection with pressure accumulator 24 or the pressure side of pump 26, and the (low) pressure in the case of a connection with tank 28 or the suction side of pump 26.

Safety valve block 23 includes first safety valve 52 to close or open (interrupt) the connection of supply line 45 with pressure accumulator line 56. When first safety valve 52 is open, volume flow regulating valves 22, 31 as well as shifting pressure regulating valve 32 are uncoupled from pressure accumulator 24 and pump 26. Safety valve block 23 also includes second safety valve 53, to which line segment 21.1 and line segment 21 with feed line 55 for tank 28 are connected. Safety valve block 23 also includes third safety valve 54, to which line segment 30.1 and line segment 30 with feed line 55 are connected. Safety valve block 23 has an operating position in which first volume flow regulating valve 22, second volume flow regulating valve 31 and shifting pressure regulating valve 32 are connected to pressure accumulator 24. In this position, hydraulic lines 21 and 30 are also switched so that they are pressure-tight. In the other position, the emergency position, hydraulic lines 21 and 30 are connected to the tank; at the same time, the connection of first volume flow regulating valve 22, second volume flow regulating valve 31 and shifting pressure regulating valve 32 to the pressure accumulator is interrupted. First and second regulating valves 22, 31 make it possible to pressurize the respective assigned hydraulic lines 21 and 30, by producing a connection to feed line 45, which is connected to pressure accumulator 24 through safety valve block 23.

Volume flow regulating valves 22 and 31 can be opened in any (intermediate) position desired; they are continuously adjustable valves, which can control a volume flow. Both volume flow regulating valves 22, 31 have a position in which hydraulic lines 21 and 30 are directly connected to tank 28, so that the particular assigned hydraulic cylinder 19, 20 is completely depressurized.

The volume flow from pump 26 and pressure accumulator 24 passes directly to safety valve block 23, and from there is conveyed further to the two volume flow regulating valves 22, 31 as well as shifting pressure regulating valve 32. When safety valve block 23 is switched, all system components are disconnected from the pressure supply, the filling of pressure accumulator 24 however continues to be maintained. The actuation of first hydraulic cylinder 19 and of second hydraulic cylinder 20 is identical in principal; it is realized by means of volume flow regulating valves 22, 31. Behind first volume flow regulating valve 22 first orifice plate 46 is situated; correspondingly, second orifice plate 47 is situated behind volume flow regulating valve 31. Orifice plates 46, 47 produce a pressure differential, depending on the volume flow. The resulting pressure differential in the case of first volume flow regulating valve 22 is returned to first supply line 48, and correspondingly in the case of second volume flow regulating valve 31 to second supply line 49; when pressurized, supply lines 48, 49 apply a pressure to the valve piston (not shown in greater detail) of the respective valve. The pressure differential due to the respective orifice plate 46, 47 acts to close the control edge of volume flow regulating valves 22, 31. This makes regulation of the clutch independent of the current system pressure or reservoir fill level of pressure accumulator 24. Optionally, pressure regulating valves or directional valves can also be used at this point to regulate the clutches.

Between volume flow regulating valves 22, 31 and hydraulic cylinders 19, 20 the hydraulic oil is passed once again through safety valve block 23, in such a way that when safety valve block 23 is actuated the residual pressures of hydraulic cylinders 19, 20 are conveyed directly from safety valve block 23 into tank 28. Accordingly, safety valve block 23 fulfills three functions: it closes accumulator 24 so that a greater volume flow does not have to be discharged into tank 28, it connects the system and any residual pressures contained therein directly to tank 28, and it empties hydraulic cylinders 19 and 20 into tank 28 in a direct way. The shift cylinder is actuated with the aid of shifting pressure regulating valve 32 and of rotary valve 33, which is operated by stepper motor 50.

If shifting pressure regulating valve 32 switches to tank 28, then seven cylinders are connected to the tank and one cylinder is pressurized. The latter will then move accordingly. In FIG. 1 for example output 40 is pressurized, so that it can move accordingly in such a way that gear five is selected. If shifting pressure regulating valve 32 reverses, then the seven cylinders are under pressure and the eighth is connected to tank 28 and therefore yields in that direction. In the position of rotary valve 33 shown in FIG. 1 this means that gear five is deselected and gear seven is selected. The reversal of shifting pressure regulating valve 32 means that output 41 of the shifting pressure regulating valve is connected to pressure accumulator 24 and output 35 is connected to tank 28.

Safety valve system 23, volume flow regulating valves 22 and 31 as well as shifting pressure regulating valve 32 are operated by electric actuators 57.1 or 57.2 or 57.3 or 57.4. The system depicted in FIG. 1 can be operated without pressure sensors. This is possible because the positions of the selector forks and the state of the clutches are detected by means of distance sensors which are not depicted here. Thus sufficient information for regulating the valves can be given to an electronic control system by means of the distance signal. A system pressure sensor can be replaced with a less expensive distance sensor on the pressure accumulator. Since the pressure accumulator functions according to the principle of a diaphragm spring, the position of the diagram spring can be picked up for example with a Hall sensor, and in this way the on and off points for the pump can be determined. If this should no longer be ensured due to a sensor defect or a malfunction of the electronic control system, the pressure accumulator is protected against overload by pressure relief valve 29 (pressure limiting valve).

### LIST OF REFERENCES

10 dual clutch transmission
11 shift cylinder
12 shift cylinder
13 shift cylinder
14 shift cylinder
15 first transmission input shaft
16 first clutch
17 second transmission input shaft
18 second clutch
19 first hydraulic cylinder
20 second hydraulic cylinder
21 hydraulic line
22 first volume flow regulating valve
23 safety valve block
24 pressure accumulator
25 check valve
26 pump
27 oil filter
28 tank
29 pressure relief valve
30 hydraulic line
31 second volume flow regulating valve
32 shifting pressure regulating valve
33 rotary valve
34 input
35 output
36 first input of rotary valve 33
37 second input of rotary valve 33
38 output
39 output
40 output
41 output
42 output
43 first return line
44 second return line
45 supply line
46 first orifice plate
47 second orifice plate
48 first supply line to volume flow regulating valve 31
49 second supply line to volume flow regulating valve 31
50 stepper motor
51 selector valve arrangement
52 first safety valve
53 second safety valve
54 third safety valve
55 supply line to tank 28
56 pressure accumulator line
57.1, 57.2, actuators
57.3, 57.4 actuators

What is claimed is:

1. A dual clutch transmission comprising a first clutch (16), which is hydraulically actuated by a first hydraulic cylinder (19), and a second clutch (18), which is hydraulically actuated by a second hydraulic cylinder (20), in addition to a plurality of hydraulically actuated shift cylinders (11, 12, 13, 14) for shifting gears, which can be subjected to pressure (p1, p2) by means of a selector valve arrangement (51), wherein the first hydraulic cylinder (19) and the second hydraulic cylinder (20) and the selector valve arrangement (51) are connected to a pressure side of a pressure device (24, 25, 26, 27, 28) by means of safety valves (52, 53 54), which are actuated in unison.

2. The dual clutch transmission according to claim 1, wherein the safety valves (52, 53, 54) connect the first hydraulic cylinder (19) and the second hydraulic cylinder (20) and the selector valve arrangement (51) to the pressure device (24, 25, 26, 27, 28) in an operating position, and in an emergency position separate the first hydraulic cylinder (19) and the second hydraulic cylinder (20) and the selector valve arrangement (51) from the pressure device (24, 25, 26, 27, 28).

3. The dual clutch transmission according to claim 2, wherein the first hydraulic cylinder (19) and the second hydraulic cylinder (20) are depressurized in the emergency position.

4. The dual clutch transmission according to claim 2, wherein the shift cylinders (11, 12, 13, 14) are depressurized in the emergency position.

5. The dual clutch transmission according to claim 1, wherein the safety valves (52, 53, 54) are combined in a safety valve block (23).

6. The dual clutch transmission according to claim 1, wherein the shift cylinders (11, 12, 13, 14) include pistons, and the shift cylinders arranged in pairs, and the pairs of pistons are coupled together into a double piston, wherein one shift cylinder (11, 12, 13, 14) in each pair can be pressurized with a high pressure (p1) and the other shift cylinders in the pair can be pressurized with a low pressure (p2).

7. The dual clutch transmission according to claim 6, wherein one shift cylinder (11, 12, 13, 14) of one the pair is connected to each output (38, 39, 40, 41) of a reversing valve (33), and one output (38, 39, 40, 41) of the reversing valve is connected to a first input (36) of the reversing valve (33) and the remaining outputs (38, 39, 40, 41) of the reversing valve are connected to a second input (37) of the reversing valve (33) in a hydraulically conductive connection, and where the shift cylinders (11, 12, 13, 14) of the double pistons that are not connected to the outputs of the reversing valve are connected to the second input (37) of the reversing valve (33), and the first and second inputs (36, 37) of the reversing valve (33) can alternately be pressurized with the high pressure (p1) or the low pressure (p2).

8. The dual clutch transmission according to claim 7, wherein the first input of the reversing valve (33) is connected to a first output (35) of a shifting pressure regulating valve (32) and the second input (37) of the reversing valve is connected to a second output (42) of the shifting pressure regulating valve (32), while first and second outputs (35, 40) of the shifting pressure regulating valve (32) can be connected alternately to a first input of the shifting pressure regulating valve (32) at which the high pressure (p1) is present and a second input of the shifting pressure regulating valve (32) at which the low pressure (p2) is present.

9. The dual clutch transmission according to claim 7, wherein the reversing valve (33) is a rotary valve.

10. The dual clutch transmission according claim 1, wherein the pressure device is a pressure accumulator (24) which is charged with a hydraulic fluid by a hydraulic pump (26).

11. The dual clutch transmission according to claim 10, wherein the high pressure (p1) is approximately equal to the pressure on a pressure side of the hydraulic pump and the low pressure (p2) approximately the pressure on a suction side of the hydraulic pump.

12. The dual clutch transmission according to claim 11, wherein the pressure on the suction side of the pump is approximately the pressure in a tank for a hydraulic fluid.

13. A hydraulic system for actuating a dual clutch transmission, comprising a first clutch (16) which is actuated hydraulically by a first hydraulic cylinder (19) and a second clutch (18) which is actuated hydraulically by a second hydraulic cylinder (20), as well as a plurality of hydraulically actuated shift cylinders (11, 12, 13, 14) for shifting gears, which can be subjected to pressure (p1, p2) by means of a selector valve arrangement (51), wherein that the first hydraulic cylinder (19) and the second hydraulic cylinder (20) and the selector valve arrangement (51) are connected to a pressure side of a pressure device (24, 25, 26, 27, 28) through safety valves (52, 53, 54) which are actuated in unison.
